(19) United States
(12) Patent Application Publication
(10) Pub. No.: US 2025/0254525 A1
(43) Pub. Date: Aug. 7, 2025

(54) Device Enrollment using Serialized Application

(71) Applicant: Telefonaktiebolaget LM Ericsson (publ), Stockholm (SE)

(72) Inventors: Ola Angelsmark, Ystad (SE); Per Persson, Södra Sandby (SE); Joakim Persson, Lund (SE); Per Skarin, Lund (SE)

(21) Appl. No.: 18/613,287

(22) Filed: Mar. 22, 2024

Related U.S. Application Data
(63) Continuation of application No. 17/052,239, filed on Nov. 2, 2020, now abandoned.

(51) Int. Cl. H04W 12/30; G16Y 30/10; H04W 4/50; H04W 4/70; H04W 4/80; H04W 12/77

(52) U.S. Cl. CPC H04W 12/35; G16Y 30/10; H04W 4/50; H04W 4/70; H04W 4/80; H04W 12/77

(57) ABSTRACT

Disclosed herein is a method of a first device for initiating and assisting an enrollment process of a second device to an Internet of Things (IoT) environment. The method comprising obtaining a representation of an enrollment function associated with the second device, wherein the enrollment function is associated with at least one serialized enrollment application comprising enrollment information associated with the first and second device and deserializing the enrollment application such that enrollment information associated with the first device is separated from enrollment information associated with the second device. The method also comprises transmitting the enrollment information associated with the second device to the second device for initiating execution by the second device of the enrollment process of the second device by configuration of the second device based the enrollment information associated with the second device and receiving from the second device configuration information associated with the second device.

### RELATED APPLICATIONS

This application is a continuation of U.S. patent application Ser. No. 17/052,239 filed 2 Nov. 2020, which is a U.S. National Phase Application of PCT/EP2018/061262 filed 3 May 2018. The entire contents of each aforementioned application is incorporated herein by reference.

### TECHNICAL FIELD

The present invention relates generally to the field of communication in Internet of Things (IoT) systems/environments. More particularly, it relates to enrollment of devices into IoT-systems.

### BACKGROUND

The Internet of things (IoT) is commonly known as a network of physical devices, vehicles, home appliances, and/or other items embedded with electronics, software, sensors, actuators, and connectivity which typically enable the devices to connect and exchange data.

Adding a new device to an IoT system or IoT environment (the terms may be used interchangeably in this disclosure), or deploying an entire IoT system for the very first time typically includes:
physically installing the devices, i.e. sensors, actuators, etc., at their respective physical location;
configuring the devices with identity and other attributes, such as e.g. geographical location, owner, purpose, etc.;
setting up communication parameters, e.g. Wi-Fi access points and passwords, encryption keys and certificates; and
enrollment of the devices, registering them with (cloud) services that will make use of them, and that they will make use of.

A typical example is e.g. installing a new surveillance system (either residential or commercial). Each device is preconfigured with its functionality, but typically requires specific configuration which may vary based on situation, context and/or intended usage, such as location (e.g. the living room) and communication (e.g. how to contact the communications hub of the IoT system). The communication hub should typically be configured with contact details to the owner, such as phone number (for GSM/GPRS communication) or network address (for IP-based communication), and password for services. Typically, some of the parameters can be configured en masse (e.g. during manufacture), and some of them should be configured after installment.

There exist various ways of handling the enrollment of the devices. Common ways typically include:
configuring a device before/directly after installation. It is typically common to allow the devices to be “trusting” when first started (known as TOFU, Trust On First Use). This allows the installer or operator to easily configure the IoT devices by means of either using no security at all, or by using security credentials set during manufacturing such as user or password combination that are common for all of the devices and which often can be found on the Internet. A typical drawback with this approach is that its vulnerable to man-in-the-middle attacks, and that security is easily compromised since the default passwords often are left unchanged after configuration, enabling further tampering.
bootstrapping the devices by typically having them “phone home” to a pre-determined address in order to receive configuration parameters. However this approach requires Internet access, or access to at least one pre-determined address typically using IP-based communication.

Hence, the conventional approaches for enrollment of devices to IoT environments are typically insecure and/or inflexible.

Therefore, there is a need for providing secure and flexible means for device enrollment in IoT systems.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof.

It is an object of some embodiments to obviate and/or mitigate at least some of the above disadvantages and to provide methods, arrangements and computer program products for enabling secure and/or flexible enrollment of devices in IoT environments.

According to a first aspect, this is achieved by a method of a first device for initiating and assisting an enrollment process of a second device to an Internet of Things (IoT) environment. The method comprises obtaining a representation of an enrollment function associated with the second device, wherein the enrollment function is associated with at least one serialized enrollment application comprising enrollment information associated with the first and second device.

The method also comprises deserializing the enrollment application such that enrollment information associated with the first device is separated from enrollment information associated with the second device.

The method according to the first aspect also comprises transmitting the enrollment information associated with the second device to the second device for initiating execution, by the second device, of the enrollment process of the second device by configuration of the second device based the enrollment information associated with the second device.

The method also comprises receiving from the second device configuration information associated with the second device.

In some embodiments, the second device is an Internet of Things (IoT) device and the first device is a wireless communication device.

In some embodiments, the representation of the enrollment function is one or more of a QR-code, a bar code and a RF-ID chip.

In some embodiments, the enrollment information associated with the second device is unknown to the second device.

In some embodiments, the enrollment information associated with the second device comprises at least one of public encryption keys, software systems, capabilities, steps pertaining to the enrollment process and functions of the IoT-environment.

In some embodiments, the enrollment information comprises information associated with one or more of geographical location, organizational location, ownership, encryption keys, communication parameters, communication keys and identity.

In some embodiments, the enrollment information comprises steps of the enrollment process which may be carried out by the first device and/or the second device during execution of the enrollment process. E.g. how the enrollment process is to be carried out, in what order and when. Further steps may be what information that should be requested or transmitted to the device that assists with the enrollment.

In some embodiments, enrollment function comprises at least two serialized enrollment applications and the method may further comprise deserializing the at least two serialized enrollment applications into at least one enrollment application comprising enrollment information associated with the first device and at least one enrollment application comprising enrollment information associated with the second device and further transmitting the at least one enrollment application associated with the second device to the second device.

In some embodiments, the method may further comprise determining that the second device has successfully enrolled and terminating the at least one enrollment application on the first device.

A second aspect is a method of a second device for executing an enrollment process to an Internet of Things (IoT) environment initiated and assisted by a first device.

The method comprises receiving, from the first device, enrollment information associated with the second device.

The method also comprises executing the enrollment process by configuring the second device based on the enrollment information and transmitting configuration information associated with the second device to the first device.

In some embodiments, the method further comprises determining that the enrollment is successful, and deleting the enrollment information from the second device.

It should be noted that the term “deleting” may be interpreted as remove or end, and may in this disclosure be substituted by the term “terminating” unless otherwise specified.

In some embodiments, the enrollment information associated with the second device is unknown to the second device.

In some embodiments, the enrollment information associated with the second device comprises at least one of public encryption keys, software systems, capabilities, steps pertaining to the enrollment process and functions of the IoT-environment.

A third aspect is a computer program product comprising a non-transitory computer readable medium. The non-transitory computer readable medium has stored there on a computer program comprising program instructions. The computer program is configured to be loadable into a data-processing unit, comprising a processor and a memory associated with or integral to the data-processing unit. When loaded into the data-processing unit, the computer program is configured to be stored in the memory. Furthermore, the computer program, when loaded into and run by the processor is configured to cause the processor to execute method steps according to any of the methods described in conjunction with the first and second aspects.

A fourth aspect is an arrangement of a first device for initiating and assisting an enrollment process of a second device to an Internet of Things (IoT) environment. The arrangement comprises a controlling circuitry configured to cause obtaining of a representation of an enrollment function associated with the second device, wherein the enrollment function is associated with at least one serialized enrollment application comprising enrollment information associated with the first and second device.

The controlling circuitry is also configured to cause deserializing of the enrollment application such that enrollment information associated with the first device is separated from enrollment information associated with the second device.

The controlling circuitry is also configured to cause transmission of the enrollment information associated with the second device to the second device for initiating execution, by the second device, of the enrollment process of the second device by configuration of the second device based the enrollment information associated with the second device.

The controlling circuitry is also configured to cause reception from the second device of configuration information associated with the second device.

A fifth aspect is a wireless communication device comprising the arrangement according to the fourth aspect.

A sixth aspect is an arrangement of a second device for executing an enrollment process to an Internet of Things (IoT) environment and assisted by a first device. The arrangement comprises a controlling circuitry configured to cause reception, from the first device, of enrollment information associated with the second device.

The controlling circuitry is also configured to cause execution of the enrollment process by configuring the second device based on the enrollment information and cause transmission of configuration information associated with the second device to the first device.

A seventh aspect is an Internet of Things (IoT) device comprising the arrangement according to sixth aspect.

In some embodiments, the first, second, third, fourth, fifth, sixth and seventh aspects may additionally have features identical with or corresponding to any of the various features as explained for each of the aspects.

An advantage of some embodiments is that an executable application is encoded e.g. as a QR-code and distributed together with an IoT device. When registering the IoT device, the application is decoded and deployed as a distributed application on the IoT device as well as on another device, e.g. a mobile phone used for enrollment of the IoT device. The embodiments disclosed herein do hence not rely on central server/repository for software.

Furthermore, the embodiments herein allows for straight forward automated registration, configuration and enrollment of devices without requiring access to e.g. the Internet or any other connectivity other than means of communicating with a registration device (such as e.g. Bluetooth, NFC, Wi-Fi, etc.).

Furthermore since the device to be enrolled is not preconfigured with all necessary information for the enrollment, security is enhanced.

### BRIEF DESCRIPTION OF THE DRAWINGS

Further objects, features and advantages will appear from the following detailed description of embodiments, with reference being made to the accompanying drawings, in which:

FIG. 1 is a flowchart illustrating example method steps according to some embodiments;

FIG. 2 is a flowchart illustrating example method steps according to some embodiments;

FIG. 3 is a schematic drawing illustrating an enrollment process according to some embodiments;

FIG. 4 is a flowchart illustrating example method steps according to some embodiments;

FIG. 5 is a block diagram illustrating an example arrangement according to some embodiments;

FIG. 6 is a block diagram illustrating an example arrangement according to some embodiments; and

FIG. 7 is a block diagram illustrating a computer program product according to some embodiments.

### DETAILED DESCRIPTION

In the following, embodiments will be described where secure and flexible enrollment of devices to IoT systems/environments is enabled by means of methods and arrangements as described herein.

As previously mentioned in the background section, adding a new device to a system, or deploying an IoT system for the very first time, typically includes
physically installing the devices,
configuring them with identity and other attributes,
setting up communication parameters, and
enrollment of the devices.

A typical example is e.g. adding a new controller to a factory automation system. The controller typically needs to know who is allowed to configure/reconfigure control loops, and where and how to send warnings/errors. It furthermore typically requires private keys for encrypting communication, and it typically requires knowing how to communicate with other devices and services (i.e. receive information on certificates, keys, etc.).

However, as previously mentioned, conventional enrollment processes may typically lead to unsecure systems since the configuration of the devices may be performed again by using the same default password, or enrollment is inhibited by the fact that Internet connection is required.

It is typically known that any computer application can be serialized in some form. Computer serialization is typically the process of translating data structures or object states into a format that can be stored or transmitted and reconstructed later (possibly in a different computer environment). The opposite operation, extracting a data structure from a series of bytes, is typically known as deserialization.

The serialization, however, may have to be complex and detailed, and thus requiring more storage space, unless the environment the application will be executing in has support for high-level abstractions of even quite complex functionality.

The serialization/deserialization described herein may be done according to any suitable method for serializing/deserializing data.

According to some embodiments herein, the application may e.g. be an enrollment application comprising enrollment information for assisting/enabling execution of enrollment of a device to the IoT environment.

For example, encoding the enrollment application using a limited format such as QR codes or barcodes adds some restrictions on the available space (even a high-density format such as HCCB is limited to approx. 300 bytes/cm²).

However, using a high-level description of the enrollment application, it is possible to encode the application, complete with internal state, parameters etc., as a string, barcode or QR Code using a limited amount of space by using serialization.

According to some embodiments, this fact may be utilized in order to provide a secure encoded enrollment process which does not require Internet connection.

For example according to some embodiments herein, an enrollment application may be distributed over several devices, or several enrollment applications may in some embodiments be running on different devices where one device may be used for assisting in enrollment of another device, and may retrieve information on geographical & organizational location, ownership, encryption keys, communication parameters (e.g. Wi-Fi access point, login credentials and address to gateway or web service, etc.) from the assisting device, storing it persistently on e.g. one or more of the devices being enrolled. Furthermore, it may in the state of the application(s) be included all information necessary to assume ownership of the device from which information has been retrieved such as e.g. keys for communication and identity.

These enrollment applications are then serialized and supplied together with one or more IoT devices e.g. by means of a note inside the package, or printed on the side of the device, or generated and printed on the receipt, or downloaded from the manufacturers website, or distributed in some other form.

Obtaining the code e.g. by means of an assisting device e.g. a mobile phone, or otherwise retrieving it, and then de-serializing by e.g. using an application or function in the mobile phone gives a digital representation of the enrollment application, which can then be deployed on a system consisting of at least the IoT-device and (for example) the mobile phone used for enrollment.

It should be noted that the assisting device does not necessarily have to be a mobile phone, but could also in some embodiments be another IoT device, or other suitable device for deserializing the enrollment information.

The enrollment application may be distributed over the at least two devices (the IoT device(s) to be enrolled, and the mobile phone assisting the enrollment) and starts executing an enrollment process by delivering all relevant information to the IoT device as well as the mobile phone.

The enrollment application may also comprise enrollment information pertaining to steps of the enrollment that may in some embodiments need to be performed by either or both of the assisting device (e.g. the mobile phone) and the IoT device to be enrolled.

The IoT device stores the enrollment information persistently, terminates the application and then resumes its intended operation.

The IoT device could optionally burn a fuse or something similar to prevent tampering or changing the data, thus making ownership permanent. The mobile phone could optionally forward the result of the registration to a server.

In an IoT framework, using fairly high-level abstractions to describe functionality, i.e. functionality is described on a semantically high level using high level descriptions such as “trigger alarm” rather than detailed and low level commands such as “set_pin (18, 0)”, it is possible to encode even quite large and complex applications as bar codes or QR codes which can be interpreted by e.g. a mobile device. The application itself can be either a distributed application covering several devices, or separate applications exchanging data.

The encoded application can then e.g. in some embodiments be either:
1) Printed on the IoT device
2) Included on a note in the IoT device packaging
3) Downloaded in batch from a web-service using unique identifiers supplied with IoT device.

Other options for delivering the encoded application are of course possible.

The technician or operator installing the IoT device may then use a mobile device as an assisting device to obtain the barcode/barcodes (e.g. by scanning the code) and deploy the application or applications. The application (or parts of an application) executing on the mobile phone then fills in configuration data such as location, purpose, ownership, credentials and other important information, whereas the application (or parts of an application) on the device to be enrolled stores this information persistently.

After the configuration/enrollment has completed, the application is disposed of, and the IoT device resumes normal operation, using the supplied configuration/enrollment data.

This approach allows for straightforward automated registration, configuration and enrollment of e.g. IoT devices without the devices requiring access to the Internet, or any other connectivity other than a means of communicating with a registration device (Bluetooth, NFC, Wi-Fi, etc.)

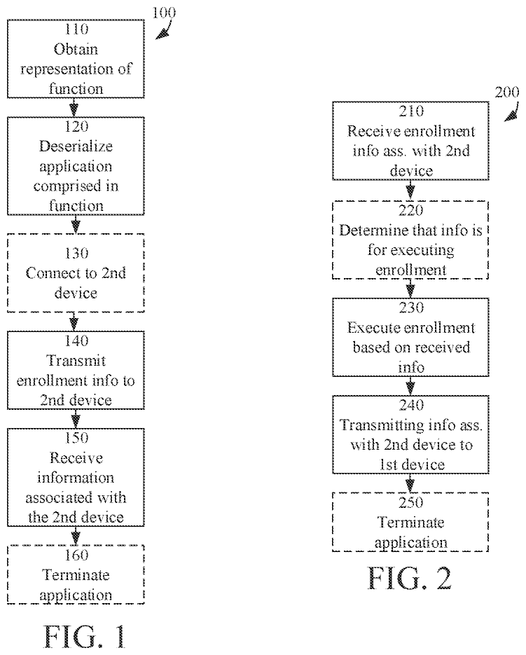

FIG. 1 illustrates an example method 100 of a first device according to some embodiments for initiating an enrollment process of a second device to an Internet of Things (IoT) environment.

The first device may e.g. be wireless communication device such as a mobile phone. The first device may be any device capable of deserializing high level abstractions, such as a handheld computer, lap top or surf pad. Although a mobile device is preferable it is not excluded that the first device is a stationary device, such as e.g. a stationary computer.

The second device may e.g. be a robot, physical device, sensor, camera or any other device suitable for an IoT system.

In some embodiments, the second device is an Internet of Things (IoT) device. In some embodiments the first device is a wireless communication device.

The method 100 starts in 110 with obtaining 110 a representation of an enrollment function associated with the second device, wherein the enrollment function is associated with at least one serialized enrollment application comprising enrollment information associated with the first and second device.

The representation of the enrollment function may e.g. be obtained by means of scanning the representation or otherwise capture the representation using e.g. a camera or other sensor.

The representation of the enrollment function may e.g. be a QR code printed on the second device, or supplied in the packaging of the second device or similar. The representation of the enrollment function could additionally or alternatively be e.g. a bar code or an RF-ID chip capable of analogue or digital storing of the serialized enrollment function. Other representations are possible.

The enrollment information associated with the first and second device comprised in the serialized enrollment application may e.g. comprise one or more of instructions for setting up communication between the first and second device, an indication of that an enrollment process is to be carried out, steps of an enrollment process, information associated with one or more of geographical location, organizational location, ownership, encryption keys, communication parameters, communication keys and identity, and information on what parameters should be exchanged between the devices such as credentials etc.

For example, the above parameters may represent a mix of information flowing between both devices. Additional data, originating in the first device, such as e.g. geographical location, organizational location, and ownership may be data sent by the first device to the second device and stored by the latter.

Encryption and communication keys/parameters may further be sent in either direction (e.g. during handshake, negotiation of means of communication etc.) during the deployment of the enrollment application, i.e. during the enrollment process.

Identity could be either sent from second device to first device (in the case of serial number or unique identifier set during manufacturing) or from first device to second device (in the case of human readable name, or identifier within organization.

The method 100 then continues in step 120 with deserializing the enrollment application such that enrollment information associated with the first device is separated from enrollment information associated with the second device.

Hence, the first and the second device may not necessarily receive the same enrollment information. The enrollment information associated with the first device may e.g. comprise instructions on which parameters the first device should supply to the second device. In the same manner, the enrollment information associated with the second device may comprise instructions that an enrollment is to take place, and directives on what parameters and/or information associated with the second device which the second device should supply the first device with.

It is to be noted that the parameters may comprise the same data as the information, i.e. the parameters may be the information or vice versa, hence in this disclosure the term parameter may be replaced by the term information if not explicitly stated otherwise.

In some embodiments, the method 100 may optionally comprise the step of connecting 130 to the second device in order to enable communication between the first and second device.

The connection may e.g. be established by means of e.g. BlueTooth, Wi-Fi, NFC, and physical connection or cable between the devices. However, this step may also be integrated into the next step of transmitting 140 the enrollment information associated with the second device to the second device for initiating execution by the second device of the enrollment process of the second device by configuration of the second device based on the enrollment information associated with the second device.

Hence, the deserialized enrollment information associated with the second device is transmitted from the first device to the second device, in order to initiate the enrollment process and enable the second device to execute the enrollment process as indicated by the (with the second device) associated enrollment information.

According to some embodiments, the enrollment information associated with the second device is unknown to the second device. Hence, enrollment cannot take place unless the first device supplies the second device with the enrollment information comprised in the deserialized enrollment application associated with the second device.

Furthermore, in some embodiments, the enrollment information associated with the second device comprises at least one of public encryption keys for communicating with the IoT system, software systems, capabilities and functions of the IoT-environment.

The method then continues with receiving 150 from the second device configuration information associated with the second device.

As elaborated on above, the enrollment information associated with the second device may comprise instructions that the second device should supply the first device with certain configuration information/parameters associated with the second device that is unknown to the first device.

Such configuration information associated with the second device may e.g. be physical identity of the second device, and public encryption keys for communication with the second device. The information associated with the second device may also in some embodiments comprise an acknowledgement of successful enrollment of the second device.

The first device may e.g. store the received configuration information and may in some embodiments relay it to the IoT system in order to enable connection of the second device to the IoT system.

E.g., according to some embodiments, for IoT-systems depending on a central cloud service, the necessary communication details (such as public keys, and identity) may to be forwarded to the cloud service in order to enable (secure) communication.

In some embodiments, the enrollment function may comprise or represent at least two serialized enrollment applications. In such case, one application may be intended for the first device, and one application may be intended for the second device.

The method may hence in some embodiments further comprise deserializing the at least two serialized enrollment applications into at least one enrollment application comprising enrollment information associated with the first device and at least one enrollment application comprising enrollment information associated with the second device. The first device may then transmit the at least one enrollment application associated with the second device to the second device.

Hence, according to some embodiments, the enrollment function may contain one application (i.e. one split application for both devices, or just one for the second device) or two applications (one for the first device and one for second device) and may also in some embodiments comprise specific configuration data (address, etc, that might not be part of any of the applications).

In some embodiments, the method may further comprise determining that the second device has successfully enrolled and terminating 160 the at least one enrollment application on the first device.

The determination of that the second device has successfully enrolled may e.g. be based on an indication received from the second device of successful enrollment. In some embodiments, the indication of successful enrollment may be comprised in the information received from, and associated with, the second device.

Hence, the method 100 describes steps for initiating and assisting e.g. an IoT device to enroll to an IoT system according to some embodiments.

Furthermore, FIG. 2 illustrates an example method 200 of a second device for executing an enrollment process to an Internet of Things (IoT) environment initiated and assisted by a first device.

The first and second device may e.g. be the first and second device as described in conjunction with FIG. 1.

The method 200 starts in 210 with receiving 210, from the first device, enrollment information associated with the second device (compare with step 140 of the method 100). The enrollment information may originate from at least one deserialized enrollment application, which enrollment application may have been deserialized by the first device according to the method 100.

In some embodiments, the method 200 may further comprise determining 220 that the enrollment information is for executing the enrollment process.

The second device may e.g. comprise different functions and processes which may be initiated when specific instructions or signals are received. The second device may e.g. comprise a function for enrollment which is utilized only when the correct enrollment information for executing the enrollment process is received.

This step may however also be performed automatically when the second device receives the enrollment information, i.e. the reception of the enrollment information may automatically trigger the enrollment process, and the step 220 may hence be seen as implicit in the method 200.

The method 200 then continues with executing 230 the enrollment process by configuring the second device based on the enrollment information.

The second device may e.g. already at least in part have access to the enrollment process but may lack certain information or parameters which may be supplied by the first device. The second device may e.g. have, as mentioned above, been configured at manufacture with a function for enrollment, this function may comprise some steps that should be taken by the device during enrollment but may e.g. lack information on certain necessary parameters or steps.

The enrollment information may hence comprise information which is unknown to the second device until the enrollment process is being deployed. Such information may e.g. pertain to information originating in the first device, such as e.g. geographical location, organizational location, gateway credentials, and (public) encryption keys for communication with the IoT system and ownership which may sent from the first device to the second device and stored by the latter.

In some embodiments, the enrollment information associated with the second device comprises at least one of public encryption keys, software systems, capabilities and functions of the IoT-environment.

In some embodiments, the enrollment information associated with the second device is unknown to the second device. Hence enrollment cannot take place unless initiated by the first device.

The method 200 may then continue with transmitting 240 configuration information associated with the second device to the first device (compare with step 150 of the method 100).

The configuration information associated with the second device transmitted to the first device may e.g. be one or more of physical identity of the second device and public encryption keys for communication with the second device. The configuration information associated with the second device may also in some embodiments comprise an acknowledgement of successful enrollment of the second device.

In some embodiments, the method 200 may further comprise determining that the enrollment is successful, and possibly terminating 250 the enrollment application e.g. by deleting the enrollment information from the second device.

In order to further strengthen security of the enrollment process and hinder future tampering of the data, the second device may e.g. blow a fuse, or in other manners delete the possibility to reconfigure it.

Furthermore, the information associated with the second device transmitted to the first device may also in some embodiments comprise an acknowledgement of successful enrollment of the second device.

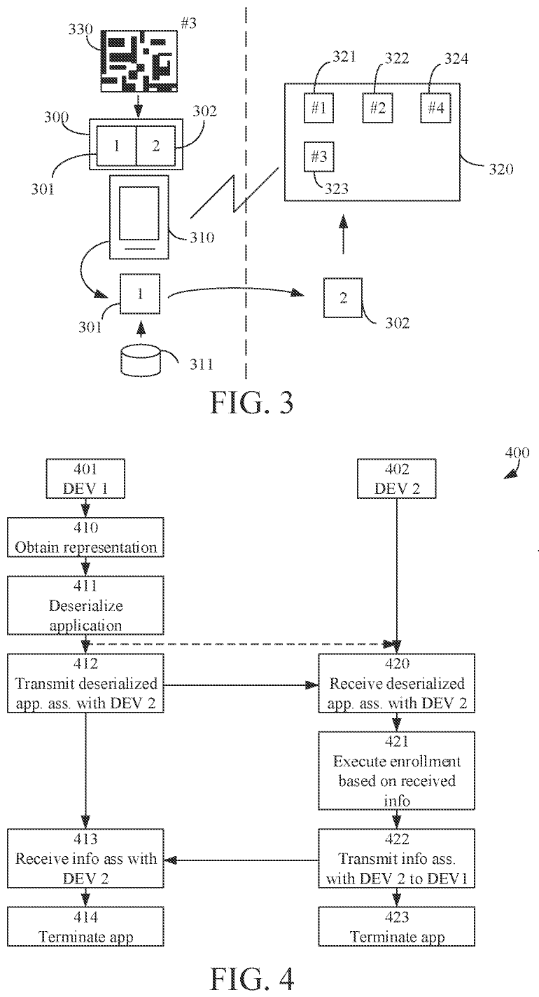

FIG. 3 illustrates schematically the execution of the methods 100 and 200 according to some embodiments.

A representation of an enrollment function 330 comprises at least one serialized enrollment application 300 which in turn comprises enrollment information 301, 302 associated with a first device 310 and a second device 320 respectively. The first and the second device may e.g. be the first and second device as described in conjunction with any of the FIGS. 1 and 2.

In this example, the representation of the enrollment function is a QR-code. But other representations are possible, such as bar codes, numeric sequences, RF-ID chips, etc.

The first device obtains the representation of the enrollment function, e.g. by scanning using a scanner or camera, or other means for detecting, acquiring or capturing the representation.

The first device 310 may then deserialize the enrollment application such that enrollment information 301 associated with the first device 310 is separated from enrollment information 302 associated with the second device 320 (compare with step 120 of the method 100).

In some embodiments, the first device may further obtain additional configuration information pertaining to the second device from an external data base 311, and may further in some embodiments be prompted by the enrollment application to obtain said additional configuration data from said external storage data base 311.

The first device keeps the enrollment information 301 associated with the first device and transmits the enrollment information 302 associated with the second device 320 to the second device 320 (compare with steps 140 and 210 of the methods 100 and 200 respectively).

It should be noted that the enrollment function may comprise more than one serialized application. In the case of more than one serialized applications, the first device and the second device may be associated with one application each, and the first device may deserialize the applications into one application for the first device and one application for the second device.

In the case of a single serialized application, the first device may deserialize it into information pertaining to the first device, and into information pertaining to the second device, i.e. split the application on the two devices. In some embodiments, in the case with one serialized application, the single application may be intended for the second device only.

The second device may in turn comprise a number of functions which may be associated with different processes. In this example, the second device may comprise function #1-#4, 321, 322, 323, and 324 respectively. These functions may have been configured/added to the second device during manufacture.

In this particular example the representation of the enrollment function information 330 corresponds to function #3, 223. Hence, when the second device receives the deserialized information it will determine that function #3 is to be initiated. In this case, function #3 is the enrollment process (compare with step 220 of the method 200).

Function #3 may comprise some enrollment steps but may lack information which may be provided in the enrollment information obtained from the deserialized enrollment application and received by the second device 320, compare e.g. with the methods 100 and 200.

The second device may then perform the enrollment according to the received enrollment information. In some embodiments, also the first device may use the enrollment information associated with the first device as well as the information received from and associated with the second device in order to configure itself.

It should be noted that also the other functions of the second device may be used for enrollment. Hence, it should be understood that the enrollment function does not comprise of a single function (e.g. function #3) but may also be instructions involving one or more of the other functions on the second device. E.g., the enrollment information may e.g. comprise instructions telling the second device to execute function #1 using parameters a, b and execute function #4 using parameters x, y etc., with functions #1 and #4 being pre-existing functions.

It should be noted that the methods 100 and 200 are closely related as they are performed respectively by a first device and a second device in order to enable enrollment of the second device. Hence, the method 100 and 200 may in some embodiments be combined into one method 400 as illustrated by FIG. 4.

In FIG. 4, a first device (DEV 1) 401, and a second device (DEV 2) 402 may communicate with each other. The first device 401 and the second device 402 may e.g. be the first and second device as respectively described in conjunction with any of the FIGS. 1-3. In the same manner the method 400 may be a combination of the methods 100 and 200 as previously described.

The method 400 starts in 410 where the first device 401 obtains a representation of an enrollment function associated with the second device 402 (compare with step 110 of the method 100). The representation may e.g. be one or more of a QR-code, barcode or similar. The representation may e.g. be obtained through scanning or NFC reader other suitable means.

The representation of the enrollment function comprises or is associated with at least one serialized enrollment application, which enrollment application may comprise enrollment information associated with the first device and with the second device respectively. The serialization enables large amounts of data to be stored in the representation using limited space.

The representation may in some embodiments be stored on the second device. The barcode may e.g. be printed onto the housing of the second device, or it could be supplied on e.g. a piece of paper and be part of the packaging of the second device. It may also be possible in some embodiments to retrieve the representation from e.g. the Internet.

When the first device has obtained the representation of the enrollment function, the method continues in 411 where the first device deserializes the serialized enrollment application in order to extract the digital representation of the information as well as separate the enrollment information which is associated with the first device from the enrollment information which is associated with the second device (compare with step 120 of the method 100).

The enrollment function may in some embodiments comprise a single serialized enrollment application which is deserialized into different blocks of information pertaining to the first or second device. In some embodiments, the enrollment function may comprise more than one serialized enrollment applications, which may be deserialized into one or more applications intended for the first device and one or more applications intended for the second device.

In some embodiments, in the case of a single application, the single application may be intended entirely for one of the devices.

After obtaining, the method 400 may comprise establishing a connection between the first device and the second device for communication (as indicated by the dashed arrow between the first and second device, compare with step 130 of the method 100). The connection may e.g. be established through a Bluetooth connection, NFC, Wi-Fi, or by cable and does not necessarily require Internet or network access.

The connection may be initiated as a separate step of the method, or it may be automatically performed or triggered after having obtained the representation. It may hence be integrated as an implicit action into the next step 412 of transmitting the enrollment information associated with the second device extracted from the deserialized enrollment application to the second device (compare with step 140 of the method 100).

The enrollment information comprised in the enrollment application may to some extent be unknown to the devices prior to deployment of the enrollment process. Hence, the representation of the enrollment function may comprise enrollment information associated with e.g. the second device, which the second device is not aware of as it has not been previously configured with the information.

Such enrollment information may e.g. be credentials associated with e.g. the first device or the IoT system into which the second device is to enroll. Such as e.g. credentials necessary for communicating with other devices or services in the IoT system, as well as ownership, location (e.g. GPS coordinates or address), a human readable name of the second device, or other information that is not known before the time of the enrollment. Other such information may e.g. be geographical location of the second device, organizational location and ownership.

In step 420 of the method 400 the second device receives the enrollment information associated with the second device comprised in the deserialized enrollment application (compare with step 210 of the method 200). This reception may trigger the second device to initiate an enrollment process (compare e.g. to FIG. 3 and the steps 220-230 of the method 200).

Hence in step 421 of the method 400 the second device executes the enrollment process based on the received enrollment information (compare with step 230 of the method 200).

During the enrollment process additional data may be exchanged between the first and second device, such data may e.g. be encryption keys, credentials, identity of the devices etc.

The second device may e.g. transmit in step 422 information associated with the second device to the first device (compare with step 240 of the method 200). Such information may e.g. be public encryption keys, software versions, capabilities and functions associated with the second device, etc.

The second device may also transmit an indication or acknowledgement to the first device that enrollment has been successful.

In step 413 of the method 400, the first device receives from the second device the information associated with the second device (compare with step 150 of the method 100). The first device may e.g. store this information and relay it to the IoT system in order to enable connection of the second device to the IoT system.

Then, after successful enrollment, in step 414 and 423 the first and second device may terminate the enrollment application at their own end respectively (compare with steps 160 and 250 of the methods 100 and 200 respectively). In order to further strengthen security once the enrollment has been completed, the second device may e.g. burn a fuse which hinders further tampering of data, or completely delete the enrollment functionality.

It is contemplated that the enrollment information may comprise instructions to the second device on what actions should be taken when the enrollment is complete, or the second device may already be preconfigured with these steps.

It is also contemplated that the first device may be configured during the enrollment process of the second device. This may be the case when the first device is a part of the IoT system and should maintain knowledge of the second device. The first device may in such case configure itself based on the enrollment information comprised in the serialized enrollment application and the information received from the second device during execution of the enrollment process. This would be the case when, for example, the first device acts as a gateway which the second device utilizes for communication with the IoT system.

The first and second devices described herein are typically physical devices, however in some embodiments the first device comprises more computing resources than the second device. It should however be noted that both the first and the second device may be IoT devices.

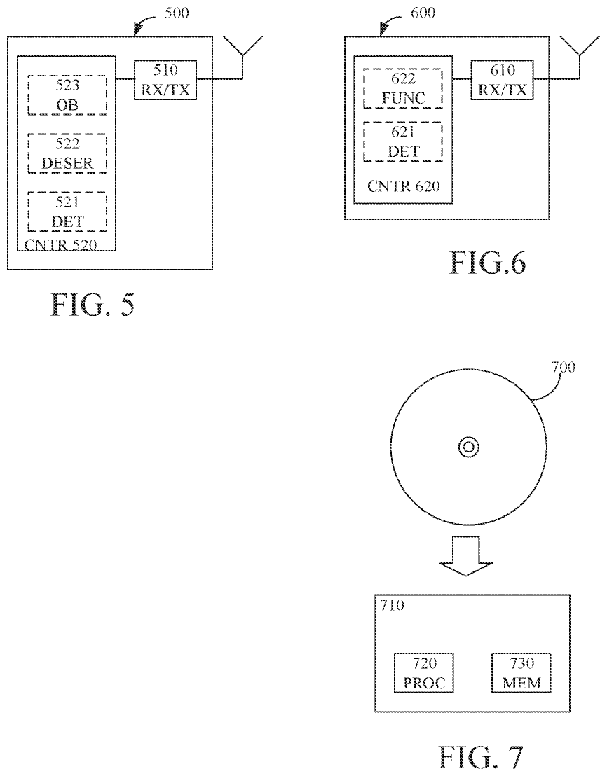

FIG. 5 illustrates an example arrangement 500 of a first device for initiating and assisting an enrollment process of a second device to an Internet of things (IoT) environment according to some embodiments.

It is to be noted that in this disclosure, the term arrangement is to be interpreted as a system of aggregated components such as e.g. a circuit board with integrated or removeably attached components. The term arrangement may e.g. be replaced by the term system.

The first device may e.g. be the first device as described in conjunction with any of the FIGS. 1-4. The second device may e.g. be the second device as described in conjunction with any of the FIGS. 1-4.

The arrangement 500 may be further configured to carry out the methods as described in conjunction with any of the FIGS. 1 to 4.

The arrangement 500 comprises a controlling circuitry (CNTR; e.g. a controller) 520 and a transceiver circuitry (RX/TX; e.g. a transceiver) 510. In some embodiments, the controlling circuitry may further comprise an obtaining circuitry (OB; obtaining module) 523, a deserializing ciruitry (DESER; e.g. a derserializer) 522 and a determination circuitry (DET; e.g. a determiner) 521.

The transceiver circuitry 510 may in some embodiments be a separate transmitter and a separate receiver.

The controlling circuitry 520 may be configured to cause obtaining, e.g. by causing the obtaining circuitry 523, of a representation of an enrollment function associated with the second device, wherein the enrollment function is associated with at least one serialized enrollment application comprising enrollment information associated with the first and second device (compare with step 110 of the method 100).

The obtaining circuitry may e.g. comprise a camera, supplied on a mobile phone. The obtaining circuitry 523 may in some embodiments be any suitable circuitry/means for obtaining or capturing information comprised in an image or on a chip or similar.

The controlling circuitry 520 may be further configured to cause deserializing, e.g. by causing the deserializing circuitry522, of the enrollment function information such that enrollment information associated with the first device is separated from enrollment information associated with the second device (compare with step 120 of the method 100).

The controlling circuitry 520 may be further configured to cause connection, e.g. by causing the transceiver circuitry to signal the second device, to the second device, such that communication between the first and second device is enabled (compare with step 130 of the method 100).

The controlling circuitry 520 may be further configured to cause transmission, e.g. by causing the transceiver circuitry 510 to signal the second device, of the enrollment information associated with the second device to the second device for initiating execution by the second device of the enrollment process of the second device by configuration of the second device based the enrollment information associated with the second device (compare with step 140 of the method 100).

During and/or after execution of the enrollment process, the controlling circuitry may be further configured to cause, e.g. by causing the transceiver circuitry to receive, reception from the second device of configuration information associated with the second device (compare with step 150 of the method 100).

In some embodiments, the controlling circuitry 520 may be further configured to cause determination, e.g. by causing the determination circuitry 521, that the enrollment process is being executed or has been completed e.g. based on the reception of the information from the second device. The controlling circuitry may then be configured to cause the storage (e.g. in a memory not shown in FIG. 5) of the information received from the second device and the relay of the information to the IoT system.

In some embodiments, the controlling circuitry 520 may further configured to cause the termination of the enrollment application e.g. when it has been determined that the enrollment of the second device has been completed and/or when the first device has performed a configuration of itself based on the deserialized enrollment application comprising enrollment information associated with the first device (compare with step 160 of the method 100).

The arrangement 500 may e.g. be comprised in a wireless communication device. A wireless communication device may e.g. be a mobile phone, smart phone, surf pad, laptop, hand held computer, or similar. The arrangement 500 may also in some embodiments be comprised in an IoT device such as a camera, robot, sensor etc.

FIG. 6 illustrates an arrangement 600 of a second device for executing an enrollment process to an Internet of things (IoT) environment and assisted by a first device.

The first and second devices may e.g. be the first and second device respectively described in conjunction with any of the FIGS. 1-5.

It should be noted that the arrangement 600 may further be combined with or comprise the same or similar features as those described in conjunction with FIG. 5 and the arrangement 500.

The arrangement 600 may e.g. be configured to carry out the methods as described in conjunction with any of the FIGS. 1-4.

The arrangement 600 may comprise a controlling circuitry (CNTR; e.g. a controller) 620 and a transceiver circuitry (RX/TX; e.g. a transceiver) 610. The transceiver circuitry 610 may in some embodiments be a separate transmitter and a separate receiver and/or comprise multiple antennas.

The controlling circuitry 620 may in some embodiments further comprise a functionality circuitry (FUNC; e.g. a functionality module) 622 and a determination circuitry (DET; e.g. a determiner) 621.

The controlling circuitry 620 may in some embodiments be configured to cause reception, e.g. by causing the transceiver circuitry 610, from the first device, enrollment information associated with the second device (compare with step 210 of the method 200).

In some embodiments, the controlling circuitry 620 may be further configured to cause determination, e.g. by causing the determination circuitry 621, of that the enrollment information is for executing the enrollment process (compare with step 220 of the method 200).

In some embodiments, the controlling circuitry 620 may further be configured to cause execution, e.g. by causing the functionality circuitry 622, of the enrollment process by configuring the second device based on the enrollment information (compare with step 230 of the method 200) and cause transmission of configuration information associated with the second device to the first device, e.g. by causing the transceiver circuitry 610 to transmit to the first device (compare with step 240 of the method 200).

In some embodiments, the controlling circuitry 620 may be further configured to terminate the enrollment application when enrollment/configuration has been completed (compare with step 250 of the method 200).

The arrangement 600 may in some embodiments be comprised in an Internet of Things (IoT) device. Such a device may e.g. be a robot, kitchen appliance, camera, sensor, traffic light, machine etc.

FIG. 7 illustrates a computer program product comprising a non-transitory computer readable medium 700, wherein the non-transitory computer readable medium 700 has stored there on a computer program comprising program instructions. The computer program is configured to be loadable into a data-processing unit 710, comprising a processor (PROC) 730 and a memory (MEM) 720 associated with or integral to the data-processing unit. When loaded into the data-processing unit 710, the computer program is configured to be stored in the memory 720, wherein the computer program, when loaded into and run by the processor 730 is configured to cause the processor to execute method steps according to any of the methods described in conjunction with the FIGS. 1-2 and 4.

An advantage with the embodiments described herein is that an executable application is encoded e.g. as a QR-code and distributed together with an IoT device. When registering the IoT device, the application is decoded and deployed as a distributed application on the IoT device as well as on another device, e.g. a mobile phone used for enrollment of the IoT device. The embodiments disclosed herein do hence not rely on central server/repository for software.

Furthermore, the embodiments herein allows for straight forward automated registration, configuration and enrollment of devices without requiring access to e.g. the Internet or any other connectivity other than means of communicating with a registration device (such as e.g. Bluetooth, NFC, Wi-Fi, etc.).

Furthermore since the device to be enrolled is not preconfigured with all necessary information for the enrollment, security is enhanced.

The described embodiments and their equivalents may be realized in software or hardware or a combination thereof. They may be performed by general-purpose circuits associated with or integral to a communication device, such as digital signal processors (DSP), central processing units (CPU), co-processor units, field-programmable gate arrays (FPGA) or other programmable hardware, or by specialized circuits such as for example application-specific integrated circuits (ASIC). All such forms are contemplated to be within the scope of this disclosure.

Embodiments may appear within an electronic apparatus (such as a wireless communication device) comprising circuitry/logic or performing methods according to any of the embodiments. The electronic apparatus may, for example, be a portable or handheld mobile radio communication equipment, a mobile radio terminal, a mobile telephone, a base station, a base station controller, a pager, a communicator, an electronic organizer, a smartphone, a computer, a notebook, a USB-stick, a plug-in card, an embedded drive, or a mobile gaming device.

Reference has been made herein to various embodiments. However, a person skilled in the art would recognize numerous variations to the described embodiments that would still fall within the scope of the claims. For example, the method embodiments described herein describes example methods through method steps being performed in a certain order. However, it is recognized that these sequences of events may take place in another order without departing from the scope of the claims. Furthermore, some method steps may be performed in parallel even though they have been described as being performed in sequence.

In the same manner, it should be noted that in the description of embodiments, the partition of functional blocks into particular units is by no means limiting. Contrarily, these partitions are merely examples. Functional blocks described herein as one unit may be split into two or more units. In the same manner, functional blocks that are described herein as being implemented as two or more units may be implemented as a single unit without departing from the scope of the claims.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely for illustrative purpose and by no means limiting. Instead, all variations that fall within the range of the claims are intended to be embraced therein.

What is claimed is:

1. A method performed by a wireless communication device, the method comprising:
obtaining, via a sensor of the wireless communication device, encoded information associated with an Internet-of-Things (IoT) device;
deserializing the encoded information to obtain first instructions defining assisting operations to be performed by the wireless communication device to assist enrollment of the IoT device in an IoT system, and second instructions defining supporting operations to be performed by the IoT device for the enrollment; and
participating in an enrollment process defined by the first and second instructions based on: wirelessly connecting to the IoT device, transferring the second instructions for execution by the IoT device, and executing the first instructions in coordination with execution of the second instructions by the IoT device.

2. The method according to claim 1, wherein wirelessly connecting to the IoT device comprises establishing a direct wireless connection with the IoT device.

3. The method according to claim 1, wherein the second instructions comprise an enrollment application executable by the IoT device.

4. The method according to claim 3, wherein the enrollment application includes configuration information to be used by the IoT device in the enrollment process.

5. The method according to claim 4, wherein the configuration information comprises communication details for the IoT system, for use by the IoT device in communicating with the IoT system.

6. The method according to claim 5, wherein the communication details comprise at least one of an identifier of the IoT system or a public key to be used for securely communicating with the IoT system.

7. The method according to claim 1, wherein deserialization of the encoded information further provides one or both of an IoT application and IoT configuration information, for operation of the IoT device in the IoT system after completion of enrollment, and wherein participating in the enrollment process by the wireless communication device further comprises transferring the IoT application or the IoT configuration information to the IoT device.

8. The method according to claim 7, wherein the wireless communication device transfers the IoT application to the IoT device, the IoT application comprising executable or interpretable code that defines IoT operation of the IoT device after completion of enrollment.

9. The method according to claim 7, wherein the wireless communication device transfers the IoT configuration information to the IoT device, the IoT configuration information configuring how one or more IoT operations of the IoT device are performed, after completion of the enrollment.

10. The method according to claim 1, wherein participating in the enrollment process by the wireless communication device further comprises obtaining from the IoT device communication details needed by the IoT system for communicating with the IoT device and forwarding the communication details to the IoT system.

11. The method according to claim 10, wherein forwarding the communication details to the IoT system comprises forwarding the communication details via a wireless communication network that provides Internet connectivity for the wireless communication device.

12. The method according to claim 10, wherein the communication details comprise at least one of an identity of the IoT device or a public key to be used for securely communicating with the IoT device.

13. The method according to claim 1, wherein participating in the enrollment process by the wireless communication device comprises the wireless communication device transferring location information to the IoT device, the transferred location information comprising or based on a current location of the wireless communication device.

14. The method according to claim 1, wherein obtaining the encoded information comprises imaging a Quick Response (QR) code or bar code printed on packaging or documentation associated with the IoT device via a camera of the wireless communication device, as said sensor.

15. The method according to claim 1, wherein obtaining the encoded information comprises receiving the encoded information via a near field communication (NFC) interface of the wireless communication device, as said sensor.

16. A wireless communication device comprising:
first transceiver circuitry configured for communication in a wireless communication network and second transceiver circuitry configured for local, direct wireless communication with proximate devices; and
processing circuitry configured to:
obtain, via a sensor of the wireless communication device, encoded information associated with an Internet-of-Things (IoT) device;
deserialize the encoded information to obtain first instructions defining assisting operations to be performed by the wireless communication device to assist enrollment of the IoT device in an IoT system, and second instructions defining supporting operations to be performed by the IoT device for the enrollment; and
participating in an enrollment process defined by the first and second instructions based on: wirelessly connecting to the IoT device via the second transceiver, transferring the second instructions for execution by the IoT device, and executing the first instructions in coordination with execution of the second instructions by the IoT device.

17. The wireless communication device according to claim 16, wherein the processing circuitry is configured to establish a direct wireless connection with the IoT device.

18. The wireless communication device according to claim 16, wherein the second instructions comprise an enrollment application executable by the IoT device.

19. The wireless communication device according to claim 18, wherein the enrollment application includes configuration information to be used by the IoT device in the enrollment process.

20. The wireless communication device according to claim 19, wherein the configuration information comprises communication details for the IoT system, for use by the IoT device in communicating with the IoT system.

21. The wireless communication device according to claim 20, wherein the communication details comprise at least one of an identifier of the IoT system or a public key to be used for securely communicating with the IoT system.

22. The wireless communication device according to claim 16, wherein deserialization of the encoded information further provides one or both of an IoT application and IoT configuration information, for operation of the IoT device in the IoT system after completion of enrollment, and wherein, for participating in the enrollment process by the wireless communication device, the processing circuitry is configured to transfer the IoT application or the IoT configuration information to the IoT device.

23. The wireless communication device according to claim 22, wherein the processing circuitry is configured to transfer the IoT application to the IoT device, the IoT application comprising executable or interpretable code that defines IoT operation of the IoT device after completion of enrollment.
